(19) United States
(12) Patent Application Publication
(10) Pub. No.: US 2018/0361511 A1
(43) Pub. Date: Dec. 20, 2018

(54) METHOD FOR QUALITY CONTROL ON LASER PEENING CORRECTION OF AERO-ENGINE SUPPORT

(71) Applicant: GUANGDONG UNIVERSITY OF TECHNOLOGY, Guangzhou (CN)

(72) Inventors: Yongkang ZHANG, GUANGZHOU (CN); Boyong SU, GUANGZHOU (CN); Yongjun ZHANG, GUANGZHOU (CN)

(73) Assignee: GUANGDONG UNIVERSITY OF TECHNOLOGY

(21) Appl. No.: 16/116,905

(22) Filed: Aug. 30, 2018

Related U.S. Application Data
(63) Continuation of application No. PCT/CN2017/078705, filed on Mar. 30, 2017.

(30) Foreign Application Priority Data
Aug. 17, 2016 (CN) 201610682336.X

(51) Int. Cl. B23K 26/356; C21D 10/00

(52) U.S. Cl. CPC B23K 26/356; C21D 10/005

(57) ABSTRACT

A method for quality control on laser peening correction of an aero-engine support includes: building a corresponding relation database of laser peening correction parameters and welding deformations through a big data platform; refining the structure of the aero-engine support; performing welding and laser peening correction on the refined structure; performing assembly welding and laser peening correction on the support; and performing correction effect detection. According to the solution, the complicated aero-engine support is refined into three simple refined structure, and a machining sequence of section-by-section welding, section-by-section laser peening correction, assembly welding and general laser peening correction is adopted. Because the laser peening correction is performed on all the refined structure before the assembly welding, the welding deformation of the support assembly may be reduced, and the support assembly is easier to be corrected during the laser peening correction.

### CROSS-REFERENCE TO RELATED APPLICATIONS

This application is a continuation of International Patent Application No. PCT/CN2017/078705 with a filing date of Mar. 30, 2017, designating the United States, now pending, and further claims priority to Chinese Patent Application No. 201610682336.X with a filing date of Aug. 17, 2016. The content of the aforementioned applications, including any intervening amendments thereto, are incorporated herein by reference.

### TECHNICAL FIELD

The present disclosure relates to the field of manufacturing of aviation components, and in particular to a method for quality control on laser peening correction of an aero-engine support.

### BACKGROUND OF THE PRESENT INVENTION

An aero-engine support is a space frame structure formed by welding hollow steel pipes together. During welding of support joints of the aero-engine support, the base metal is heated unevenly in some parts, which easily generates a welding residual stress, so that the space frame structure may have a great residual deformation and is relatively low in shape accuracy, resulting in deviation of engine support mounting bolts from mounting positions and hence influencing subsequent assembly. At present, a method adopted in practical engineering application is to increase the size and then to cut off excess deformation in a machining way. This method is time-consuming, laborious and low in machining consistency.

At present, the existing correction method is to repeatedly apply a counteracting force to a proper position on a deformed workpiece to press a deformed region of the workpiece and hence generate a reverse plastic deformation until a desired correction result is obtained. However, the aero-engine support will have various different types of deformations after welding is completed due to its complicated structure and various welding deformation influence factors, and the deformation degrees are greatly different. In these cases, it is very hard to obtain an ideal design shape accuracy of the support by purely partial or large-area pressing. Furthermore, corrected welded joints have a relatively high residual stress which is unfavorable for the stability and subsequent machining of the workpiece and affects the actual service life of the support. Such correction would further change a geometric size that the workpiece should have, so that this method is not applicable to correction of welding deformations of aero-engine supports which have high requirements for assembly accuracy and are complicated in structure.

Therefore, how to solve the problem of deformations caused in the welding process of the aero-engine support is a current technical problem to be solved by those skilled in the art.

### SUMMARY OF PRESENT INVENTION

In view of this, a purpose of the present disclosure is to provide a method for quality control on laser peening correction of an aero-engine support to solve the problem of deformations caused in the welding process of the aero-engine support.

Aiming at above-mentioned purpose, the technical solutions are provided as follows:

A method for quality control on laser peening correction of an aero-engine support includes the following steps:

Building a corresponding relation database by determining corresponding relations between laser peening correction parameters and welding deformations through computer simulation and laser peening experiment, and analyzing and storing the corresponding relations between the laser peening correction parameters and the welding deformations through a big data platform;

Refinement the structure of the aero-engine support into a refined structure, wherein the refined structure include a straight pipe butt-welding structure, a straight pipe and round pipe butt-welding structure and a straight pipe and round pipe combination butt-welding structure;

Performing welding and laser peening correction to the refined structure by respectively welding different refined structures to obtain welded refined structure, performing welding deformation measurement on the welded refined structure, selecting, by the big data platform, the laser peening correction parameters according to welding deformations of the welded refined structures, and correcting welding deformations of the welded refined structures through a laser peening correction process;

Performing assembly welding on the different welded refined structures to obtain a support assembly, performing welding deformation measurement on the support assembly, selecting, by the big data platform, the laser peening correction parameters according to a welding deformation of the support assembly, and correcting a welding deformation of the support assembly through the laser peening correction process; and

Detecting a correction effect of the support assembly, judging whether to perform secondary correction or not on the support assembly, returning to the previous step if YES, and ending the operation if NO.

Preferably, in the method, the big data platform includes a data acquisition and storage module, a distributed computing architecture and a cloud computing module.

Preferably, in the method, the welding deformation measurement is performed through a three-dimensional shape measurement system, and the three-dimensional shape measurement system stores measured welding deformation data into the big data platform.

Preferably, in the method, the laser peening correction parameters include a laser peening power density, a number of peening times, a peening angle and a peening path.

According to the method for the aero-engine support provided by the present disclosure, the complicated aero-engine support is refined into three kinds of simple refined structures, and a machining sequence of section-by-section welding, section-by-section laser peening correction, assembly welding and general laser peening correction is adopted. According to the method, the laser peening correction is performed to all the refined structures before the assembly welding, so that the welding deformation of the support assembly is reduced, and the support assembly is easier to be corrected during the laser peening correction. The present disclosure solves the problem of the deformations of the aero-engine support in the welding process, is capable of precisely controlling the size accuracy and the shape accuracy of the support, and is good in correction effect. The obtained aero-engine support is relatively high in diameter size and shape accuracy, and meets the accuracy requirement according to the design. Furthermore, a residual compressive stress is generated on the surface of the support in the laser peening correction process, so that the service life of the support structure is prolonged. Compared with the deformation control method adopted in prior art, this solution has the advantages of high control precision, high working efficiency, material saving, prolonging of fatigue life of a structural member and the like, and meets high requirements of the standard for aero-parts.

### DESCRIPTION OF THE DRAWINGS

The present disclosure will now be described more clearly hereinafter with reference to the accompanying drawings, in which exemplary embodiments of the disclosure are shown. This disclosure may, however, be embodiment in many different forms and should not be construed as limited to the embodiments set forth herein. Under the teaching of the accompanying drawings, other drawings may be obtained by one of ordinary skill in the art without paying creative work.

FIG. 1 is a flow chart of a method according to a specific embodiment of the present disclosure;

FIG. 2 is a straight pipe butt-welding structure according to a specific embodiment of the present disclosure;

FIG. 3 is another straight pipe butt-welding structure according to a specific embodiment of the present disclosure:

FIG. 4 is a straight pipe and round pipe butt-welding structure according to a specific embodiment of the present disclosure; and

FIG. 5 is a straight pipe and round pipe combination butt-welding structure according to a specific embodiment of the present disclosure.

### DETAILED DESCRIPTION OF PREFERRED EMBODIMENTS

The main idea of the present disclosure is to provide a method for quality control on laser peening correction of an aero-engine support to solve the problem of deformations caused in a welding process of the aero-engine support.

The technical solution in the embodiments of the present disclosure is clearly and completely described below in combination with the drawings in the embodiments of the present disclosure. Apparently, the described embodiments are only part of the embodiments of the present disclosure instead of all the embodiments. On the basis of the embodiments in the present disclosure, all other embodiments obtained by those ordinarily skilled in the art without paying creative work shall all fall within the protection scope of the present disclosure.

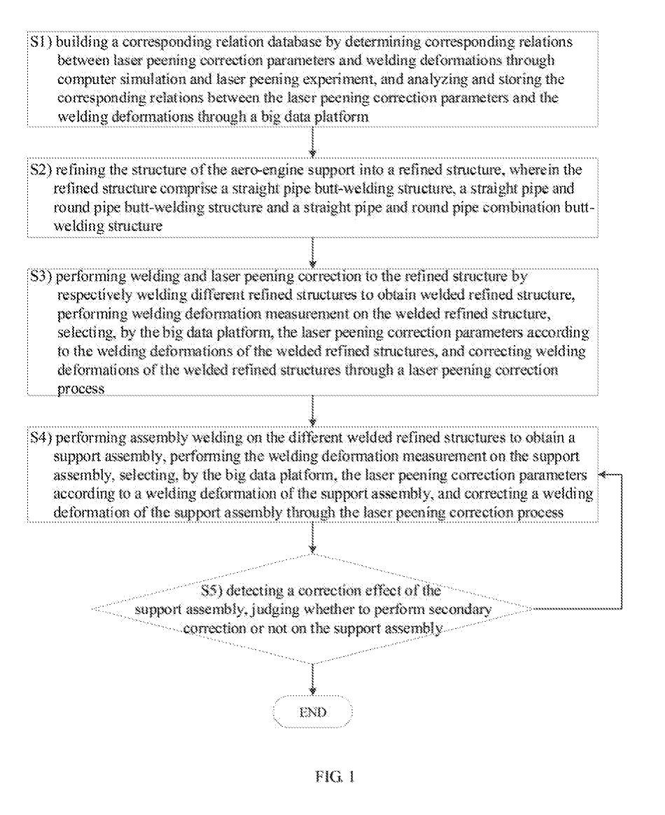

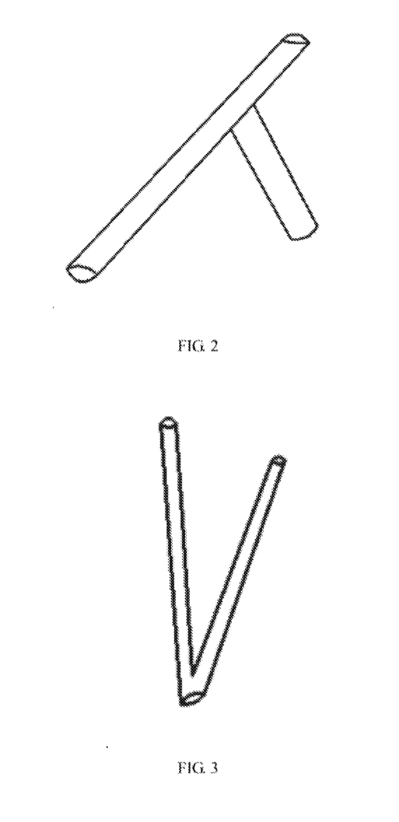

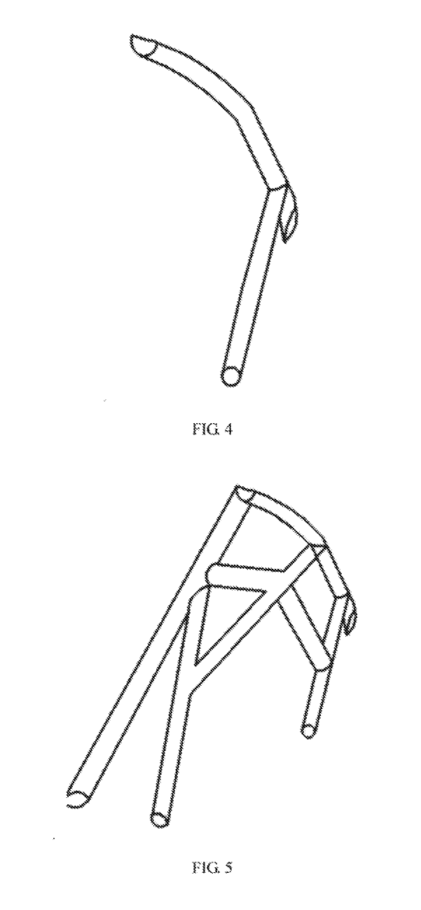

With reference to FIG. 1 to FIG. 5, FIG. 1 is a flow chart of a method according to a specific embodiment of the present disclosure, and FIG. 2 to FIG. 5 are schematic diagrams of different refined structures according to the specific embodiment of the present disclosure.

According to a specific embodiment, the present disclosure provides the following technical solution:

A method for quality control on laser peening correction of an aero-engine support includes the following steps:

S1) building a corresponding relation database by determining corresponding relations between laser peening correction parameters and welding deformations through computer simulation and laser peening experiment, and analyzing and storing the corresponding relations between the laser peening correction parameters and the welding deformations through a big data platform;

S2) refining the structure of the aero-engine support into a refined structure, wherein the refined structure include a straight pipe butt-welding structure, a straight pipe and round pipe butt-welding structure and a straight pipe and round pipe combination butt-welding structure;

S3) performing welding and laser peening correction to the refined structure by respectively welding different refined structures to obtain welded refined structure, performing welding deformation measurement on the welded refined structure, selecting, by the big data platform, the laser peening correction parameters according to welding deformations of the welded refined structures, and correcting welding deformations of the welded refined structures through a laser peening correction process;

S4) performing assembly welding on the different welded refined structures to obtain a support assembly, performing welding deformation measurement on the support assembly, selecting, by the big data platform, the laser peening correction parameters according to a welding deformation of the support assembly, and correcting a welding deformation of the support assembly through the laser peening correction process; and

S5) detecting a correction effect of the support assembly, judging whether to perform secondary correction or not on the support assembly, returning to step S4) if YES, and ending the operation if NO.

The welding deformation is a residual deformation caused by a residual pulling stress generated by uneven heating for welded joints in a welding process. A principle of the laser peening correction process is that high-density and short-pulse laser acts on planned regions (regions to be subjected to laser peening are determined according to different deformations), and residual stresses of welding deformation regions are adjusted, so as to correct the residual deformation caused in the welding process.

Preferably, in Step S1), the big data platform includes a data acquisition and storage module, a distributed computing architecture and a cloud computing module.

For the welding deformations (such as a deformation angle of an angular deformation, a deformation curvature of a bending deformation, etc.) in different deformation ways, it requires to determine the laser peening correction parameters for correction in each deformation way. The corresponding relation database in Step S1) is a database for storing required specific laser peening correction parameters corresponding to detailed deformation ways and specific deformations. It should be noted that the laser peening correction parameters include a laser peening power density, the number of peening times, a peening angle, a peening path and the like.

A detailed process of Step S1) is as follows: the welding deformations are classified and then are recorded as Xᵢ (i is a positive integer, namely i=1, 2, 3, 4, . . . ), and meanwhile, the laser peening correction parameters corresponding to different welding deformations are recorded as Gᵢ (i is a positive integer, namely i-=, 2, 3, 4, . . . ), wherein a maximum value of i is determined by a classification condition of the welding deformations, such as the classification fineness. Those skilled in the art can set the maximum value of i according to different classification conditions, so that no limitations will be made herein. The corresponding relation between the laser peening correction parameter Gᵢ and the welding deformation Xᵢ is obtained firstly through computer simulation, and then is verified and determined through laser peening experiment. Finally, the corresponding relation between the laser peening correction parameter Gᵢ and the welding deformation amount Xᵢ is stored in the data acquisition and storage module of the big data platform, thereby building the corresponding relation database.

In Step S3) and Step S4), the welded refined structure and the support assembly are respectively subjected to the welding deformation measurement. Preferably, the welding deformation measurement is performed through a three-dimensional shape measurement system, and the three-dimensional shape measurement system stores measured welding deformation amount data into the big data platform. A specific measurement process is as follows: the three-dimensional shape measurement system scans the shape of the support. A scanning system firstly scans a standard support to build a detailed standard three-dimensional shape data model of the support to serve as a comparison reference during measurement of the welding deformation. Secondly, the three-dimensional shape measurement system scans the completely welded support to obtain a welded support three-dimensional model, and compares the welded support three-dimensional model with the standard three-dimensional shape data model of the support, so as to determine detailed deformation positions, the deformation ways and the welding deformations of the welded support. In the scanning process, the surface of the support is coated with a developing agent to facilitate the measurement.

It should be noted that the three-dimensional shape measurement system is in butt connection with the data acquisition and storage module of the big data platform. The three-dimensional shape measurement system further stores the measured welding deformation data into the big data platform, and acquires the corresponding laser peening correction parameters through the computer simulation for the purpose of further enriching the corresponding relation database of the big data platform, so that the big data platform may select corresponding laser peening correction parameters closer to the measured welding deformations in a next correction process.

Specifically, in Step S3) and Step S4), the three-dimensional shape measurement system and a residual stress test device are used to respectively measure a three-dimensional deformation of the welded support and residual stresses of key regions (for example, weld regions), and input acquired three-dimensional deformation data and residual stress data into the big data platform. The cloud computing module in the big data platform is used to analyze the three-dimensional deformation of the welded support, and compare the three-dimensional deformation with a final shape of the support to determine a deformation of a part to be corrected and a correction path. The big data platform calls detailed deformation data in the data acquisition and storage module, and compares the data with the existing welding deformation data in the corresponding relation database to determine the specific laser peening correction parameters. The specific laser peening correction parameters have been determined through a mutual verification mode based on the computer simulation and laser peening experiment, and have been stored in the corresponding relation database of the big data platform.

In the above Step S3), the big data platform selects the laser peening correction parameters of the parts to be corrected of the welded refined structure according to the welding deformations of the welded refined structures. For example: the big data platform automatically searches the corresponding relation database, which is pre-stored in the big data platform, of the laser peening correction parameters and the welding deformations to find peening strengths corresponding to the welding deformations.

In the above Step S4), a laser peening correction optimal solution is selected for the support assembly, specifically as follows: after the support assembly is subjected to the welding deformation measurement and the welding deformation is determined, the assembly welding deformation of the support is compared with the existing welding deformations in the data acquisition and storage module in the big data platform, and an optimal correction solution is determined according to the existing corresponding relation database of the laser peening correction parameters and the welding deformations in the data acquisition and storage module. Preferably, selection of the laser peening correction optimal solution includes selection of the laser peening correction parameters (the laser peening power density, the number of peening times, the peening angle and the peening path) and selection of correction regions.

In the above Step S3) and Step S4, the correction performed on the welding deformations of the welded refined structures or the support assembly through the laser peening correction process is specifically that the determined laser peening correction parameters (the laser peening power density, the number of peening times, the peening angle and the peening path) are input into a laser impact device, and the laser impact device performs correction treatment on the welded refined structure and the support assembly according to the peening path determined by the big data platform.

It should be noted that in the above Step S4, it requires to judge whether a coupling influence is caused on the corrected welded refined structure or not in the assembly welding process of the support when the welding deformation measurement is performed on the support assembly. The coupling influence means that a certain part having a welding deformation may affect or deform other parts connected to this part in the assembly welding process of the support. For example: after the welded refined structure accord with required shape accuracy and size accuracy, because upper welded joints have angular deformations during welding to make distances from lower structural nodes become longer, lower welded nodes may have torsional deformations during welding. Incidental deformations caused by the coupling influence also belong to one of welding deformations, and are also required to be corrected.

In the above Step S5), the correction effect detection includes: detecting the correction effect of the support assembly, judging whether to perform secondary correction or not on the support assembly, returning to Step S4) if YES, and ending the operation if NO. The correction effect detection for the support assembly specifically includes: comparing the corrected support assembly with the standard support structure, determining whether the corrected welding deformation parts meet requirements for the size accuracy and the shape accuracy of a product, determining that the secondary correction is required to be performed on the support assembly according to a judgment result if the requirements are not met, and returning to Step S4) for re-correction; and determining that the secondary correction is not required to be performed on the support assembly according to the judgment result if the requirements are met, and ending the whole process. Through Step S5), the support assembly may be gradually close to a required correction accuracy of the product.

With reference to FIG. 2 to FIG. 5, it can be seen that the complicated aero-engine support in this solution is refined into three simple refined structure: a straight pipe butt-welding structure, namely a straight pipe and straight pipe welding structure; a straight pipe and round pipe butt-welding structure, namely a straight pipe and round pipe welding structure; and a straight pipe and round pipe combination butt-welding structure, namely a straight pipe and straight pipe+straight pipe and round pipe combination welding structure. The welding deformations of the above-mentioned three refined structure are easy to correct through the laser peening correction process, so that the welding deformations in the assembly welding process of the support may be reduced.

According to the method for the aero-engine support provided by the present disclosure, the complicated aero-engine support is refined into three simple refined structure, and a machining sequence of section-by-section welding, section-by-section laser peening correction, assembly welding and general laser peening correction is adopted. According to the method, the laser peening correction is performed to all the refined structure before the assembly welding, so that the welding deformation of the support assembly may be reduced, and the support assembly is easier to be corrected during the laser peening correction. The present disclosure solves the problem of the deformations of the aero-engine support in the welding process, is capable of precisely controlling the size accuracy and the shape accuracy of the support, and is good in correction effect. The obtained aero-engine support is relatively high in diameter size and shape accuracy, and meets the accuracy requirement according to the design. Furthermore, a residual compressive stress is generated on the surface of the support in the laser peening correction process, so that the service life of the support structure is prolonged. Compared with a deformation control method adopted in prior art, this solution has the advantages of high control precision, high working efficiency, material saving, prolonging of the fatigue life of a structural member and the like, and meets the standard of high requirements for aero-parts.

For the purpose of simplifying the descriptions, the above-mentioned method embodiments are all described as a series of action combinations, but those skilled in the art should know that the present application is not limited by the order of described actions since some steps may be performed in other orders or simultaneously according to the present application.

Those skilled in the art can realize or use the present disclosure according to the above-mentioned descriptions of the disclosed embodiments. It is obvious to those skilled in the art to make various modifications to these embodiments. General principles defined herein may be implemented in other embodiments without departing from the spirit or the scope of the present invention. Therefore, the present disclosure will not be limited to these embodiments described herein, and shall accord with the widest scope consistent with the principle and novel features that are disclosed herein.

We claim:

1. A method for quality control on laser peening correction of an aero-engine support, comprising the following steps:
building a corresponding relation database by determining corresponding relations between laser peening correction parameters and welding deformations through computer simulation and laser peening experiment, and analyzing and storing the corresponding relations between the laser peening correction parameters and the welding deformations through a big data platform;
refining the structure of the aero-engine support into a refined structure, wherein the refined structure comprise a straight pipe butt-welding structure, a straight pipe and round pipe butt-welding structure and a straight pipe and round pipe combination butt-welding structure;
performing welding and laser peening correction to the refined structure by respectively welding different refined structures to obtain welded refined structure, performing welding deformation measurement on the welded refined structure, selecting, by the big data platform, the laser peening correction parameters according to the welding deformations of the welded refined structures, and correcting welding deformations of the welded refined structures through a laser peening correction process;
performing assembly welding on the different welded refined structures to obtain a support assembly, performing the welding deformation measurement on the support assembly, selecting, by the big data platform, the laser peening correction parameters according to a welding deformation of the support assembly, and correcting a welding deformation of the support assembly through the laser peening correction process; and
detecting a correction effect of the support assembly, judging whether to perform secondary correction or not on the support assembly, returning to the previous step if YES, and ending the operation if NO.

2. The method according to claim 1, wherein the big data platform comprises a data acquisition and storage module, a distributed computing architecture and a cloud computing module.

3. The method according to claim 1, wherein the welding deformation measurement is performed through a three-dimensional shape measurement system which then stores measured welding deformation data into the big data platform.

4. The method according to claim 1, wherein the laser peening correction parameters comprise a laser peening power density, a number of peening times, a peening angle and a peening path.
